(19) United States
(12) Patent Application Publication
(10) Pub. No.: US 2020/0379518 A1
(43) Pub. Date: Dec. 3, 2020

(54) ELECTRONIC DEVICE

(71) Applicant: PEGATRON CORPORATION, TAIPEI CITY (TW)

(72) Inventors: YEN-PO CHEN, Taipei City (TW); Shao-Yu Wang, Taipei City (TW)

(73) Assignee: PEGATRON CORPORATION, TAIPEI CITY (TW)

(21) Appl. No.: 16/744,078

(22) Filed: Jan. 15, 2020

(30) Foreign Application Priority Data
May 28, 2019 (TW) 108118356

(51) Int. Cl. G06F 1/16; H01R 33/76; H01R 13/62

(52) U.S. Cl. CPC G06F 1/1654; H01R 33/7664; G06F 1/1616; H01R 33/7685; H01R 13/6205

(57) ABSTRACT

An electronic device includes a display module, a frame, and a first magnetic element. The frame has a frame body and a first connector, where the frame body forms an accommodation space, and the first connector is disposed on one side of the frame body. The display module is detachably mounted in the frame and has a second connector disposed on one side of the display module. The first connector is disposed at a position corresponding to a position of the second connector. The first magnetic element is disposed in the frame body, and when the display module mounted in the frame is attracted to the accommodation space through a magnetic force of the first magnetic element, the second connector is electrically connected to the first connector.

### CROSS-REFERENCE TO RELATED APPLICATIONS

This Non-provisional application claims priority under 35 U.S.C. § 119(a) on Patent Application No(s). TW108118356 filed in Taiwan, Republic of China on May 28, 2019, the entire contents of which are hereby incorporated by reference.

### BACKGROUND

### Technical Field

The present invention relates to an electronic device, and in particular, to an electronic device having a detachable display screen and frame.

### Description of the Related Art

Computers prevail gradually, and laptop computers are increasingly used by people because of the advantages of the laptop computers such as thin, light, and portable. At present, a display screen of a laptop computer is fixed to a host, thereby bringing the following drawback: Because the display screen and the host are attached, when one component has to be replaced due to damage or failure, the other component also has to be replaced.

In view of the above, a person skilled in the art attempts to make a structural improvement, so that the display screen of the notebook computer and the host can be separated. However, due to weights of the components and structure tightness, a connection mechanism of the host and the display screen needs to be fastened by a hand tool, and consequently it is inconvenient for disassembly and assembly.

### SUMMARY

The present invention provides an electronic device that can be easily assembled without a hand tool.

The electronic device of the present invention includes a display module, a frame, and a first magnetic element. The frame has a frame body and a first connector, where the frame body forms an accommodation space, and the first connector is disposed on a side of the frame body. The display module is detachably mounted in the frame and has a second connector disposed on a side of the display module. The first connector is disposed at a position corresponding to a position of the second connector. The first magnetic element is disposed in the frame, and when the display module mounted in the frame is attached to the accommodation space through a magnetic force of the first magnetic element, the second connector is electrically connected to the first connector.

In an embodiment of the present invention, the first connector or the second connector is a pogo pin connector.

In an embodiment of the present invention, the display module further has a first foolproof structure, and the frame body has a second foolproof structure, a position of the first foolproof structure corresponds to a position of the second foolproof structure. In addition, one of the first foolproof structure and the second foolproof structure is a tenon, and the other of the first foolproof structure and the second foolproof structure is a slot.

In an embodiment of the present invention, the electronic device further includes a second magnetic element, where the display module further includes a metal backplane, and the second magnetic element is disposed on the metal backplane of the display module and is disposed at a position corresponding to a position of the first magnetic element. The first magnetic element may be a magnet or an electromagnet, and the second magnetic element is a magnet.

Based on the above, in the electronic device of the present invention, the metal backplane is attached by the magnetic element to quickly and easily assemble the display module to the frame, and the display module can be electrically connected to the frame through cooperation of the first connector and the second connector.

To make the features and advantages of the invention clear and easy to understand, the following gives a detailed description of embodiments with reference to accompanying drawings.

### BRIEF DESCRIPTION OF THE DRAWINGS

FIG. 1 is an exploded schematic diagram of a display module and a frame.

FIG. 2 is a schematic diagram of a display module at a first view angle.

FIG. 3 is a schematic diagram of a frame and a first connector thereof.

FIG. 4 is a schematic diagram of an assembly of a display module and a frame.

FIG. 5 is a schematic diagram the display module in FIG. 2 at a second view angle.

### DETAILED DESCRIPTION

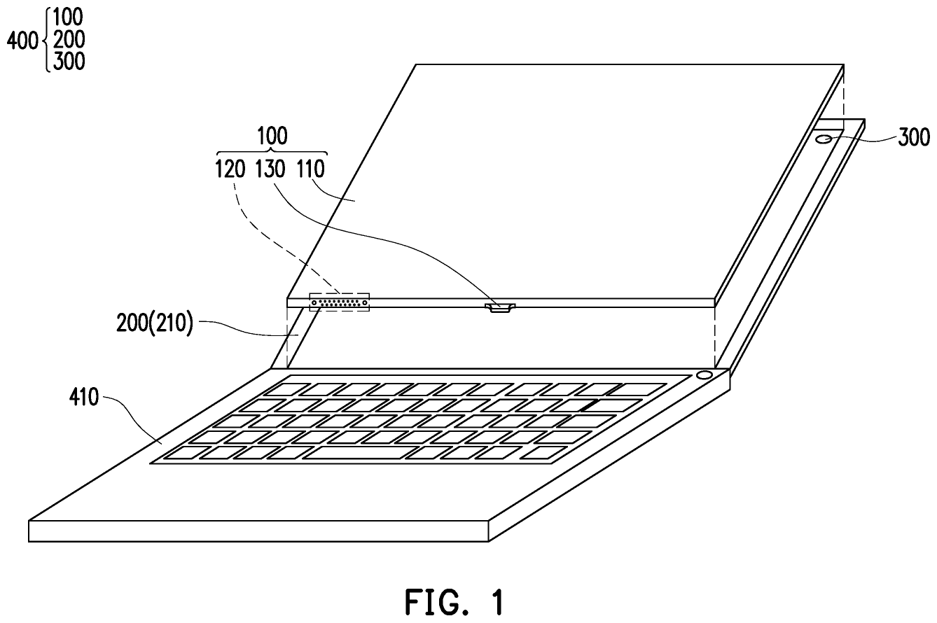

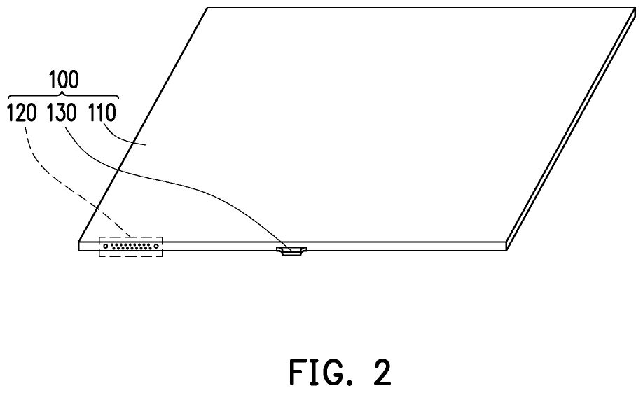

FIG. 1 is an exploded schematic diagram of a display module and a frame, and FIG. 2 is a schematic diagram of a display module at a first view angle.

Referring to FIG. 1 and FIG. 2, a display module 100 and a frame 200 are firstly provided. The display module 100 has a metal backplane 110 and a second connector 120, which is disposed on a side of the display module 100. The metal backplane 110 may cover a display unit (not shown) of the display module 100 or is directly attached to a back side of the display unit, depending on the demands.

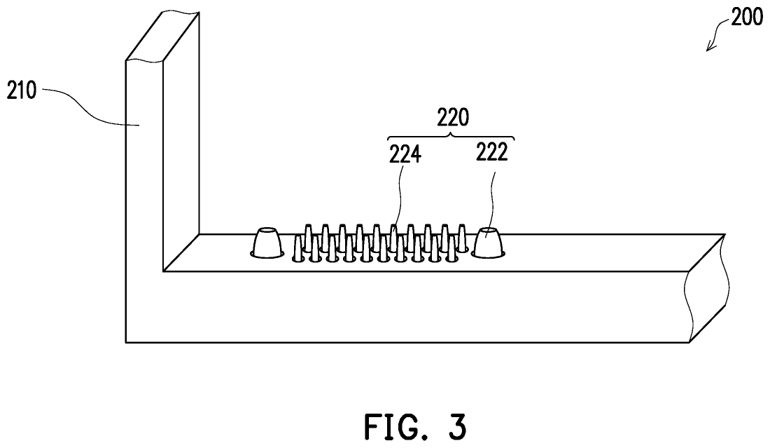

FIG. 3 is a schematic diagram of a frame and a first connector thereof. Referring to FIG. 1 and FIG. 3, the frame 200 has a frame body 210 and a first connector 220. The frame body 210 forms an accommodation space S, and the display module 100 is adapted to be detachably mounted in the accommodation space S. The first connector 220 is disposed on a side of the frame body 210, and a position of the first connector 220 corresponds to a position of the second connector 120.

It should be noted that when the frame 200 is provided, a first magnetic element 300 configured to assemble the display module 100 and the frame 200 together may already be disposed on the frame 200, for example, being disposed on the frame body 210 or in the frame body 210; or the first magnetic element 300 may be disposed on the frame body 210 or in the frame body 210 of the frame 200 through post-processing. A position of the first magnetic element 300 is determined according to the requirements.

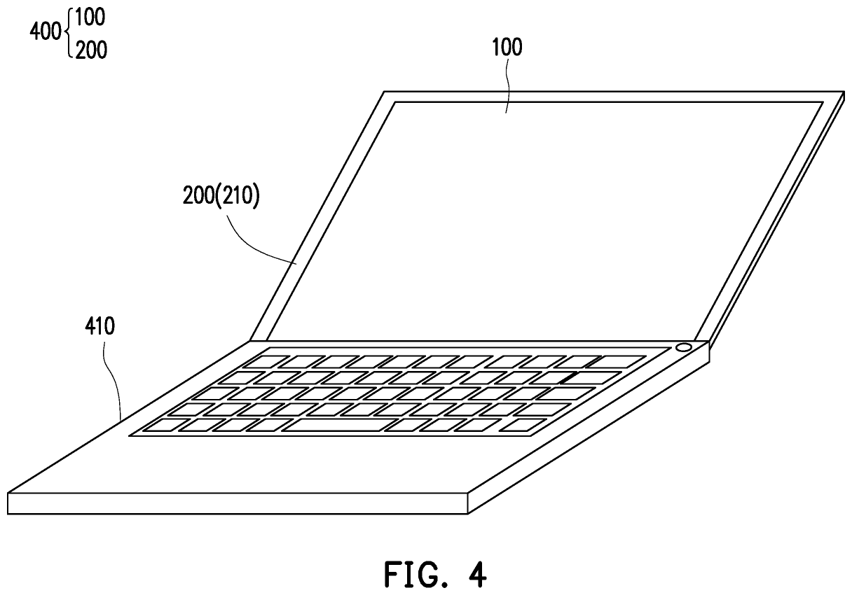

FIG. 4 is a schematic diagram of an assembly of a display module and a frame. Then, as shown in FIG. 4, the display module 100 is mounted onto the frame body 210 through magnetic attraction, and the second connector 120 is electrically connected to the first connector 220.

In particular, when a person holds two sides of the display module 100 and brings the display module 100 close to the frame body 210, the metal backplane 110 of the display module 100 is attracted to the frame 200 due to a magnetic force of the first magnetic element 300, and is located in the accommodation space S. In addition, the person needs to match the position of the second connector 120 with the position of the first connector 220, so that when the display module 100 is attached to the frame 200, the second connector 120 can be smoothly engaged with the first connector 220. As known from the above, the display module 100 and the frame 200 can be easily and quickly assembled into an electronic device 400 through providing of the first magnetic element 300. The electronic device 400 in this embodiment may be a part (for example, a screen) of a laptop computer. In other words, the electronic device 400 may be connected to a keyboard portion 410 of the laptop computer. In other embodiments, the electronic device 400 may be alternatively a mobile phone, a watch, a television, a vehicle screen, a POS machine, an electronic kanban, or the like.

As described above, in this embodiment, the first connector 220 is a pogo pin connector, and the second connector 120 is a connector whose shape corresponds to (is complementary to) the shape of the first connector 220. In addition, the second connector 120 may use an embedded display port (eDP) interface, in which Channels 1, 2, 4, or high bit rates (HBR) 1/2/3 may be used to meet different bandwidth requirements because the V-by-one transmission interface standard requires twice a quantity of channels at the same resolution. It should be noted that the first connector 220 includes a power pin 222 and a signal pin 224, and the second connector 120 correspondingly includes a power pad and a signal pad in contact with the power pin and the signal pin for electrical connection.

In addition, in order to prevent a user from mounting the display module 100 onto the frame 200 in a wrong direction, a first foolproof structure 130 may be disposed on the display module 100, and a second foolproof structure (not shown) is disposed on the frame body 210 at a position corresponding to a position of the first foolproof structure 130. In this way, it can be ensured that the user mounts the display module 100 onto the frame 200 in the correct direction, and the second connector 120 is well engaged with the first connector 220.

In this embodiment, the first foolproof structure 130 is a tenon, and the second foolproof structure (not shown) may be a slot, but is not limited thereto. In other words, the first foolproof structure 130 may be a slot, and the second foolproof structure (not shown) is a tenon.

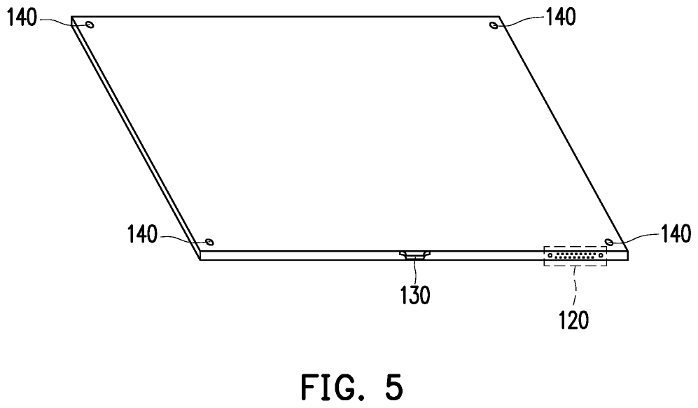

FIG. 5 is a schematic diagram of the display module in FIG. 2 at a second view angle. Referring to FIG. 5, a second magnetic element 140 may be disposed on the metal backplane 110 of the display module 100, and a position of the second magnetic element 140 corresponds to the position of the first magnetic element 300. The first magnetic element 300 and the second magnetic element 140 face each other with opposite polarities and have the magnetic attraction towards each other. In this way, an attachment effect of the display module 100 and the frame 200 can be enhanced.

In this embodiment, the first magnetic element 300 may be a magnet or an electromagnet, and the second magnetic element 140 is a magnet.

If both the first magnetic element 300 and the second magnetic element 140 are magnets, in order to facilitate detachment of the display module 100 from the frame 200, a removal hole (not shown) may be disposed in a back cover portion (not shown) of the frame body 210, or the back cover portion (not shown) may be designed as a hollowed-out portion, and therefore the user just needs a hand or a hand tool to push the display module 100 through the removal hole or the hollowed-out portion. When a force applied by the user is greater than the magnetic attraction force, the display module 100 can be detached from the frame 200.

In the case that the first magnetic element 300 is an electromagnet, when the user needs to detach the display module 100 from the frame 200, the magnetic polarities of the first magnetic element 300 and the second magnetic element 140 may be changed so the magnetic force between the first magnetic element 300 and the second magnetic element 140 changes from attraction to repelling. In this way, the person can easily detach the display module 100 from the frame 200.

Based on the above, the electronic device of the present invention facilitates assembly or disassembly.

In short, by the magnetic element attracting t the display module and the frame are quickly and easily assembled to form the electronic device, and the display module can be electrically connected to the frame through the cooperation of the first connector and the second connector.

When the display module is to be detached from the frame, the display module can be easily detached from the frame by using a hand or a hand tool or changing a polarity of the first magnetic element.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. An electronic device, comprising:
a frame having a frame body and a first connector, wherein the frame body forms an accommodation space, and the first connector is disposed on a side of the frame body;
a display module detachably mounted in the frame and having a second connector, wherein the second connector is disposed on a side of the display module, and a position of the first connector corresponds to a position of the second connector; and
a first magnetic element disposed in the frame, wherein when the display module mounted in the frame is attached to the accommodation space through a magnetic force of the first magnetic element, the second connector is electrically connected to the first connector.

2. The electronic device according to claim 1, wherein the first connector or the second connector is a pogo pin connector.

3. The electronic device according to claim 1, wherein the display module further has a first foolproof structure, and the frame body has a second foolproof structure, and a position of the first foolproof structure is disposed corresponds to a position of the second foolproof structure.

4. The electronic device according to claim 3, wherein one of the first foolproof structure and the second foolproof structure is a tenon, and the other of the first foolproof structure and the second foolproof structure is a slot.

5. The electronic device according to claim 1, further comprising a second magnetic element, wherein the display module further comprises a metal backplane, and the second magnetic element is disposed on the metal backplane of the display module and is disposed at a position corresponding to a position of the first magnetic element.

6. The electronic device according to claim 5, wherein the first magnetic element is a magnet or an electromagnet, and the second magnetic element is a magnet.
